(19) United States
(12) Patent Application Publication
(10) Pub. No.: US 2007/0054979 A1
(43) Pub. Date: Mar. 8, 2007

(54) Formulations and their use in the coloration of substrates

(75) Inventors: Ulrike Hees, Mannheim (DE); Michael Kluge, Worms (DE); Holger Schopke, Neckargemund (DE); Karl Siemensmeyer, Frankenthal (DE); Dominik Winter, Ludwigshafen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF AKTIENGESELLSCHAFT, Ludwigshafen (DE)

(21) Appl. No.: 10/575,719

(22) PCT Filed: Oct. 8, 2004
(86) PCT No.: PCT/EP04/11253

§ 371 Date: Apr. 13, 2006

(30) Foreign Application Priority Data
Oct. 14, 2003 (DE) 103 48 464.7

(51) Int. Cl. C03C 17/00; C09D 11/00; C08K 9/00

(52) U.S. Cl. 523/160; 523/161; 523/200

(57) ABSTRACT

Formulations comprising (A) at least one pigment in particulate form that has been treated according to a process which comprises steps of: (a) mixing pigment in particulate form with at least one nonionic surface-active substance, (b) dispersing the thus obtainable mixture of pigment in particulate form and nonionic surface-active substance in an aqueous medium, (c) addition polymerizing at least one first monomer or addition copolymerizing a first mixture of comonomers in the presence of a dispersion according to b) to form water-insoluble polymer or copolymer on the surface of the pigments in particulate form, (d) adding at least one second comonomer or a second mixture of comonomers and addition copolymerizing, and (B) at least one radiation-curable component.

The present invention relates to formulations comprising

(A) at least one pigment in particulate form that has been treated according to a process which comprises steps of:
(a) mixing pigment in particulate form with at least one nonionic surface-active substance,
(b) dispersing the thus obtainable mixture of pigment in particulate form and nonionic surface-active substance in an aqueous medium,
(c) addition polymerizing at least one first monomer or addition copolymerizing a first mixture of comonomers in the presence of a dispersion according to b) to form water-insoluble polymer or copolymer on the surface of the pigments in particulate form,
(d) adding at least one second comonomer or a second mixture of comonomers and addition copolymerizing, and

(B) at least one radiation-curable component.

The present invention further relates to a process for coloration of substrates and to colored substrates produced using treated pigments in particulate form in the presence of radiation-curable molecules or moieties.

Colorant preparations which are to be used in state of the art processes for coloration of substrates such as leather for example have to meet demanding requirements. Colored substrates shall exhibit colors of high brilliance and the coloration shall be durable, i.e., have high fastnesses such as rub fastness and perspiration fastness for example. In some cases, however, the brilliance of colorations leaves something to be desired. A case in point is the application of binder-containing colorant preparations when it is desired to produce trichromat. The pigments are frequently observed to migrate after application, and this can lead to unlevel colorations. Fat spews, which are encouraged by the migration of pigments and lead to discoloration and staining, are also observed occasionally. It is further observed that combination shades are very difficult if not impossible to produce and substrates which have been colored with pigment mixtures will over time acquire an uneven appearance due to the different migration rate of various pigments. Moreover, the haptics of printed substrates could do with improvement in some cases.

Very durably colored substrates are obtained when pigments (following the actual coloration) are fixed by means of a binder and crosslinked, and this can be accomplished for example by action of heat, by action of oxygen or by action of electromagnetic radiation.

The present invention thus had for its object to provide formulations which are useful for coloration of substrates and which avoid the abovementioned infirmities from the prior art. It further had for its object to provide a process for coloration of substrates. It further had for its object to provide a process for producing formulations which are useful for coloration of substrates. It lastly had for its object to provide colored substrates.

We have found that this object is achieved by the formulations defined at the beginning.

The formulations of the present invention comprise pigment in particulate form. Pigments for the purposes of the present invention are virtually insoluble, organic or inorganic colorants as per the definition in German standard specification DIN 55944. The inventive process preferably has organic pigments as its starting point.

Representative examples of organic pigments are
monoazo pigments: C.I. Pigment Brown 25; C.I. Pigment Orange 5, 13, 36 and 67; C.I. Pigment Red 1, 2, 3, 5, 8, 9, 12, 17, 22, 23, 31, 48:1, 48:2, 48:3, 48:4, 49, 49:1, 52:1, 52:2, 53, 53:1, 53:3, 57:1, 63, 112, 146, 170, 184, 210, 245 and 251; C.I. Pigment Yellow 1, 3, 73, 74, 65, 97, 151 and 183;
disazo pigments: C.I. Pigment Orange 16, 34 and 44; C.I. Pigment Red 144, 166, 214 and 242; C.I. Pigment Yellow 12, 13, 14, 16, 17, 81, 83, 106, 113, 126, 127, 155, 174, 176 and 188;
anthanthrone pigments: C.I. Pigment Red 168 (C.I. Vat Orange 3);
anthraquinone pigments: C.I. Pigment Yellow 147 and 177; C.I. Pigment Violet 31;
anthraquinone pigments: C.I. Pigment Yellow 147 and 177; C.I. Pigment Violet 31;
anthrapyrimidine pigments: C.I. Pigment Yellow 108 (C.I. Vat Yellow 20);
quinacridone pigments: C.I. Pigment Red 122, 202 and 206; C.I. Pigment Violet 19;
quinophthalone pigments: C.I. Pigment Yellow 138;
dioxazine pigments: C.I. Pigment Violet 23 and 37;
flavanthrone pigments: C.I. Pigment Yellow 24 (C.I. Vat Yellow 1);
indanthrone pigments: C.I. Pigment Blue 60 (C.I. Vat Blue 4) and 64 (C.I. Vat Blue 6);
isoindoline pigments: C.I. Pigment Orange 69; C.I. Pigment Red 260; C.I. Pigment Yellow 139 and 185;
isoindolinone pigments: C.I. Pigment Orange 61; C.I. Pigment Red 257 and 260; C.I. Pigment Yellow 109,110,173 and 185;
isoviolanthrone pigments: C.I. Pigment Violet 31 (C.I. Vat Violet 1);
metal complex pigments: C.I. Pigment Yellow 117,150 and 153; C.I. Pigment Green 8;
perinone pigments: C.I. Pigment Orange 43 (C.I. Vat Orange 7); C.I. Pigment Red 194 (C.I. Vat Red 15);
perylene pigments: C.I. Pigment Black 31 and 32; C.I. Pigment Red 123, 149, 178, 179 (C.I. Vat Red 23), 190 (C.I. Vat Red 29) and 224; C.I. Pigment Violet 29;
phthalocyanine pigments: C.I. Pigment Blue 15, 15:1, 15:2, 15:3, 15:4, 15:6 and 16; C.I. Pigment Green 7 and 36;
pyranthrone pigments: C.I. Pigment Orange 51; C.I. Pigment Red 216 (C.I. Vat Orange 4);
thioindigo pigments: C.I. Pigment Red 88 and 181 (C.I. Vat Red 1); C.I. Pigment Violet 38 (C.I. Vat Violet 3);
triarylcarbonium pigments: C.I. Pigment Blue 1, 61 and 62; C.I. Pigment Green 1; C.I. Pigment Red 81, 81:1 and 169; C.I. Pigment Violet 1, 2, 3 and 27; C.I. Pigment Black 1 (aniline black);
C.I. Pigment Yellow 101 (aldazine yellow);
C.I. Pigment Brown 22.

Specific examples of particularly preferred pigments are: C.I. Pigment Yellow 138, C.I. Pigment Red 122, C.I. Pigment Violet 19, C.I. Pigment Blue 15:3 and 15:4, C.I. Pigment Black 7, C.I. Pigment Orange 5, 38 and 43 and C.I. Pigment Green 7.

The formulations of the present invention may also comprise mixtures of two or more different treated pigments.

The formulations of the present invention comprise at least one pigment in particulate form, i.e., in the form of particles. The starting pigments are customarily crude pigments, i.e., untreated as-synthesized pigments. The particles may be regular or irregular in shape in that, for example, the particles may have a spherical or substantially spherical shape or a needle (acicular) shape.

In one embodiment of the present invention, the particles are present in spherical or substantially spherical shape, i.e., the ratio of the longest diameter to the smallest diameter is in the range from 1.0 to 2.0, preferably up to 1.5.

Formulations of the present invention comprise at least one pigment in particulate form that has been treated according to a process which is described hereinbelow and which comprises the steps a) to d) defined at the beginning.

The pigment or pigments in particulate form is or are mixed with at least one nonionic surface-active substance in a step a).

Representative examples of suitable nonionic surface-active substances are ethoxylated mono-, di- and trialkylphenols (degree of ethoxylation: 3-50, alkyl radical: C₃-C₁₂) and also ethoxylated fatty alcohols (degree of ethoxylation: 3-80; alkyl radical: C₈-C₃₆). Examples thereof are the Lutensol® brands from BASF AG or the Triton® brands from Union Carbide. Particular preference is given to ethoxylated linear fatty alcohols of the general formula III
n-CₓH₂ₓ₊₁—O(CH₂CH₂O)_{y}—H, III

where each x is an integer from 10 to 24 and preferably from 12 to 20. y is preferably an integer from 5 to 50 and more preferably from 8 to 40.

Ethoxylated linear fatty alcohols of the general formula III are typically present as a mixture of various ethoxylated fatty alcohols having different degrees of ethoxylation. y represents the number-average mean in the context of the present invention.

The mixing of pigment in particulate form and at least one nonionic surface-active substance is effected in apparatus which is suitable for mixing, preferably in mills such as for example ball mills or stirred media mills.

An example of a suitable mixing time is in the range from ½ hour to 48 hours, but longer times are conceivable. The mixing time is preferably in the range from 5 to 24 hours.

Mixing pressure and temperature conditions are generally not critical in that, for example, atmospheric pressure has been found to be suitable. As for temperatures, temperatures in the range from 10° C. to 100° C. for example have been found to be suitable.

The mixing ratio of pigment in particulate form to nonionic surface-active substance can be chosen within wide limits and may be for example in the range from 10:1 to 2:1.

Water may be added while step a) is carried out. Similarly, customary nonionic grinding assistants may be added.

The median diameter of pigment in particulate form after step a) is typically in the range from 20 nm to 1.5 μm, preferably in the range from 50 to 200 nm and more preferably 100 nm.

Step b) consists in dispersing the mixture of pigment in particulate form and nonionic surface-active substance that is obtainable according to step a) in an aqueous medium. Any desired dispersing apparatus may be used, for example stirred tanks or stirred flasks.

An aqueous medium for the purposes of the present invention is a liquid medium which comprises water as an important component, for example at not less than 40% by weight and preferably at not less than 55% by weight.

The step b) weight ratio of the mixture of pigment particles and nonionic surface-active substance to the aqueous medium is generally in the range from 1:2 to 1 :15, and preferably in the range from 1:2.5 to 1:9.

Step b) pressure and temperature conditions are generally not critical in that, for example, temperatures in the range from 5 to 100° C. are suitable, preferably from 20 to 85° C., and pressures in the range from atmospheric pressure to 10 bar.

The dispersing of step b) results in a dispersion.

Step c) consists in polymerizing at least one first monomer or copolymerizing a first mixture of comonomer in the presence of a dispersion obtainable according to b) to form water-insoluble polymer or copolymer on the surface of the pigment particles.

Step c) is carried out by adding at least one monomer or at least one mixture of comonomers to a dispersion obtainable according to b). The addition can be effected for example in one portion, in multiple portions or else continuously. To copolymerize at least different monomers with each or one another, at first one comonomer may be added and thereafter the second and if appropriate further comonomers. In another embodiment, all the comonomers are added in one portion.

Monomer and comonomers may be added neat or in aqueous dispersion.

The monomers and comonomers chosen for step c) are such monomers and comonomers as are sparingly soluble in water. “Sparingly water-soluble monomers and comonomers” is to be understood as meaning such monomers and comonomers as have a solubility in water of 1×10⁻¹ mol/l or less at 50° C.

Preferred examples of monomers and comonomers in step c) are vinyl aromatic compounds and sparingly water-soluble a unsaturated carboxylic acid derivatives.

As vinyl aromatic compound there is preferably chosen at least one compound of the general formula IV

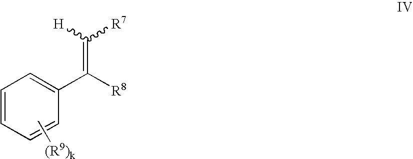

where R⁷ and R⁸ are each independently hydrogen, methyl or ethyl, R⁹ is methyl or ethyl and k is an integer from 0 to 2; most preferably, R⁷ and R⁸ are each hydrogen and most preferably k=0.

As sparingly water-soluble α,β-unsaturated carboxylic acid derivative there is preferably chosen a compound of the general formula I

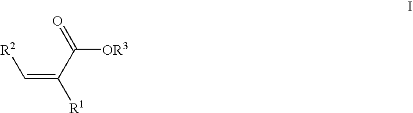

where

R¹ is selected from
branched or unbranched C₁-C₁₀-alkyl, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, ndecyl; more preferably C₁-C₄-alkyl such as methyl, ethyl, n-propyl, iso-propyl, n-butyl, iso-butyl, sec-butyl and tert-butyl;
or hydrogen,
most preferably hydrogen and methyl;

R² is selected from
branched or unbranched C₁-C₁₀-alkyl, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; more preferably C₁-C₄-alkyl such as methyl, ethyl, n-propyl, iso-propyl, n-butyl, iso-butyl, sec-butyl and tert-butyl;
or most preferably hydrogen.

R³ is selected from
branched or unbranched C₄-C₁₀-alkyl, such as n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; most particularly n-butyl and 2-ethylhexyl.

In one embodiment of the present invention, the ratio of pigment to amount of monomer or comonomers in step c) is in the range from 1:0.1 to 1:1.2 and preferably in the range from 1:0.3 to 1:0.8.

Step c) may be carried out using mixtures of the aforementioned monomers or comonomers. For example, mixtures of styrene and n-butyl acrylate are very useful, their mixing ratio being freely choosable.

Polymerizing is preferably carried out under the conditions of an emulsion polymerization. Most preferably, starved conditions are employed in that little or preferably no wetting agent is added. There are thus no detectable fractions obtained of stabilized droplets of styrene, and the wetting agent fraction serves to transport styrene through the continuous aqueous phase. Useful wetting agents include for example organic sulfur compounds, for example alkyl sulfates, alkyl sulfonates, alkylaryl sulfonates, alkyl ether sulfates, alkylaryl ether sulfates, sulfosuccinates such as sulfosuccinic monoesters and sulfosuccinic diesters; also organic phosphorus compounds such as alkyl ether phosphates for example.

The polymerization will typically be carried out using at least one initiator. At least one initiator can be a peroxide. Examples of suitable peroxides are alkali metal peroxodisulfates, for example sodium peroxodisulfate, ammonium peroxodisulfate, hydrogen peroxide, organic peroxides such as diacetyl peroxide, di-tert-butyl peroxide, diamyl peroxide, dioctanoyl peroxide, didecanoyl peroxide, dilauroyl peroxide, dibenzoyl peroxide, bis(o-tolyl) peroxide, succinyl peroxide, tert-butyl peracetate, tert-butyl permaleate, tert-butyl perisobutyrate, tert-butyl perpivalate, tert-butyl peroctoate, tert-butyl pemeodecanoate, tert-butyl perbenzoate, tert-butyl peroxide, tert-butyl hydroperoxide, cumene hydroperoxide, tert-butyl peroxy-2-ethylhexanoate and diisopropyl peroxydicarbamate. It is also possible to use azo compounds such as for example azobisisobutyronitrile, azobis(2-amidopropane) dihydrochloride and 2,2′-azobis(2-methylbutyronitrile).

Redox initiators are likewise suitable, composed for example of peroxides and an oxidizable sulfur compound. Very particular preference is given to systems formed from acetone bisulfite and organic peroxide such as tert-C₄H₉—OOH, Na₂S₂O₅ (sodium disulfite) and organic peroxide such as tert-C₄H₉—OOH or HO—CH₂SO₂H and organic peroxide such as tert-C₄H₉—OOH. Similarly, systems such as for example ascorbic acid/H₂O₂ are particularly preferred.

The polymerization temperature may be chosen in the range from 20 to 100° C. and preferably in the range from 50 to 85° C. The temperature chosen is dependent on the decomposition characteristics of the initiator used.

Pressure conditions are generally not critical, pressures in the range from atmospheric pressure to 10 bar being suitable for example.

The time for step c) is for example in the range from 1 to 30 minutes, preferably in the range from 2 to 10 minutes and more preferably in the range from 3 to 5 minutes.

It will be appreciated that further substances can be added to the reaction mixture that are customary in emulsion polymerization, for example glycols, polyethylene glycols, protective colloids and buffers/pH regulators.

Step c) provides polymer- or copolymer-coated pigment in particulate form, the pigment being obtained in the form of isolated particles. No measurable or only extremely small fractions of agglomerates are observed, for example less than 2% by weight and preferably less than 0.2% by weight.

The polymer or copolymer formed in step c) of one embodiment of the present invention at the surface of the pigment in particulate form is water-insoluble.

A further step may be carried out whereby the dispersed polymer- or copolymer-coated pigment particles obtainable according to c) are isolated by purifying operations, for example filtering, decanting, washing, and redispersed for practicing step d) of the process of the present invention. Preferably, however, the dispersed polymer- or copolymer-coated pigment particles obtainable according to step c) are further processed in situ.

Step d) of the process according to the present invention consists in adding at least one second monomer, or a second mixture of comonomers, to the dispersion from step c) or to the worked-up and redispersed coated pigments and polymerizing or copolymerizing.

The reference in the context of the present invention to a second mixture of comonomers in step d) also applies when one monomer was used in step c) and a mixture of two comonomers is added in step d). Similarly, the reference in the context of the present invention to a second monomer in step d) is to be understood as also comprehending the case where a mixture of comonomers was used in step c) and one monomer is added in step d).

When it is desired to add a second mixture of comonomers, at least one comonomer other than the monomer or the comonomers of step c) is added.

One embodiment of the present invention utilizes a vinyl aromatic monomer in step c) and at least one monomer or comonomer capable of swelling polystyrene in step d).

It is very particularly preferred to add at least one monomer or comonomer of the general formula II,

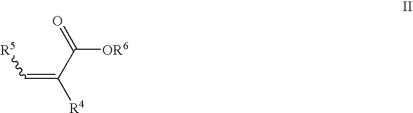

where

R⁴ is selected from
branched or unbranched C₁-C₁₀-alkyl, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; more preferably C₁-C₄-alkyl such as methyl, ethyl, n-propyl, iso-propyl, n-butyl, iso-butyl, sec-butyl and tert-butyl;
or hydrogen;

most preferably hydrogen and methyl;

R⁵ is selected from
branched or unbranched C₁-C₁₀-alkyl, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; more preferably C₁-C₄-alkyl such as methyl, ethyl, n-propyl, iso-propyl, n-butyl, iso-butyl, sec-butyl and tert-butyl;
or most preferably hydrogen.

R⁶ is selected from branched or unbranched C₁-C₁₀-alkyl, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; more preferably C₁-C₄-alkyl such as methyl, ethyl, n-propyl, iso-propyl, n-butyl, iso-butyl, sec-butyl and tert-butyl.

To add a mixture of comonomers in step d), it will be sufficient when, as well as one added radiation-curable component (B), at least one comonomer differs from the monomer or comonomer of step c). For instance, styrene may be used in step c) and a mixture of methyl acrylate and styrene in step d).

In one embodiment of the present invention, step c) utilizes styrene and step d) a mixture of hard components (components which enhance the hardness of a copolymer film) such as for example methyl acrylate and styrene and of a soft component such as for example butyl acrylate.

In one embodiment of the present invention, the second monomer or the second mixture is chosen such that the glass transition temperature of the polymer or copolymer synthesized in step d) is above 0° C. The glass transition temperature of the polymer or copolymer synthesized in step d) is preferably above 10° C. and more preferably above 20° C.

The glass transition temperature of the polymer or copolymer formed in step d) may be determined for example by performing a separate experiment under the conditions of the emulsion polymerization to prepare the corresponding pigment-free polymer or copolymer that comprises respectively no polymer or copolymer according to step c), and subsequently determining the glass transition temperature by Differential Scanning Calorimetry (DSC).

In a particularly preferred embodiment of the present invention, the step d) utilizes one or more monomers or comonomers selected from: n-butyl acrylate, 2-ethylhexyl acrylate, methyl acrylate, ethyl acrylate.

In a particularly preferred embodiment of the present invention, step d) utilizes at least 10% by weight of n-butyl acrylate.

In one embodiment of the present invention, the weight ratio of second mixture of comonomers from step d) to pigment from step a) is in the range from 0.7:1 to 10:1, preferably in the range from 1.5:1 to 5:1 and more preferably in the range from 1.7:1 to 3:1.

Overall, the amount of comonomer for steps c) and d) of the process of the present invention is chosen such that the ratio of polymer or copolymer to pigment is in the range from 1:1 to 5:1 and preferably in the-range from 2:1 to 3:1.

The polymerizing or copolymerizing of step d) is preferably carried out under the conditions of an emulsion polymerization. Typically, at least one initiator is used, and the initiator- or initiators can be chosen from those mentioned above.

It is possible to use at least one emulsifier, which may be anionic, cationic or nonionic.

Customary nonionic emulsifiers are for example ethoxylated mono-, di- and tri-alkylphenols (degree of ethoxylation: 3-50, alkyl radical: C₄-C₁₂) and also ethoxylated fatty alcohols (degree of ethoxylation: 3-80; alkyl radical: C₈-C₃₆). Examples are the Lutensol® brands from BASF Aktiengesellschaft and the Triton® brands from Union Carbide.

Customary anionic emulsifiers are for example alkali metal and ammonium salts of alkyl sulfates (alkyl radical: C₈ to C₁₂), of sulfuric acid monoesters formed from ethoxylated alkanols (degree of ethoxylation: 4-30, alkyl radical: C₁₂-C₁₈) and from ethoxylated alkylphenols (degree of ethoxylation: 3-50, alkyl radical: C₄-C₁₂), of alkylsulfonic acids (alkyl radical: C₁₂-C₁₈) and of alkylarylsulfonic acids (alkyl radical: C₉-C₁₈).

Suitable cationic emulsifiers are in general C₆-C₁₈-alkyl-, -aralkyl- or heterocyclyl-containing primary, secondary, tertiary or quaternary ammonium salts, alkanolammonium salts, pyridinium salts, imidazolinium salts, oxazolinium salts, morpholinium salts, thiazolinium salts and also salts of amine oxides, quinolinium salts, isoquinolinium salts, tropylium salts, sulfonium salts and phosphonium salts. By way of example there may be mentioned dodecylammonium acetate or the corresponding hydrochloride, the chlorides or acetates of the various 2-(N,N,N-trimethylammonium)-ethylparaffinic esters, N-cetylpyridinium chloride, N-laurylpyridinium sulfate and also N-cetyl-N,N,N-trimethylammonium bromide, N-dodecyl-N,N,N-trimethylammonium bromide, N,N-distearyl-N,N-dimethylammonium chloride and also the gemini surfactant N,N′-(lauryidimethyl)ethylenediamine dibromide. Numerous further examples are to be found in H. Stache, Tensid-Taschenbuch, Carl-Hanser-Verlag, Munich, Vienna, 1981 and in McCutcheon's, Emulsiffers & Detergents, MC Publishing Company, Glen Rock, 1989.

In one embodiment of the present invention, the amount of emulsifier is chosen such that the mass ratio between the second monomer or the second mixture of comonomers on the one hand and the emulsifier on the other is more than 8:1, preferably more than 15:1 and more preferably more than 19:1.

The order in which the reactants of step d) are added is in itself not critical.

In one embodiment of the present invention the initial step is to prepare a pre-emulsion from water, emulsifier and monomers. This pre-emulsion, which is also referred to as the emulsion feed stream, is subsequently metered into the polymerization reactor concurrently with the initiator feed stream, but via a separate addition vessel.

The polymerization temperature may be chosen in the range from 20 to 100° C. and preferably in the range from 50 to 85° C. The temperature chosen is dependent on the decomposition characteristics of the initiator used.

Pressure conditions are generally not critical, pressures in the range from atmospheric pressure to 10 bar being suitable for example.

As duration for the polymerization or copolymerization in step d) it is possible to choose a time in the range from 30 minutes to 12 hours, preference being given to the range from 2 to 3 hours. When one or more compounds of the general formula I are used as a comonomer in step d), a time from 40 to 60 minutes is also conceivable.

In one embodiment of the present invention, step d) utilizes as a comonomer up to 5% by weight and preferably from 1% to 4% by weight based on monomers or comonomers of step d) of at least one compound of the general formula V

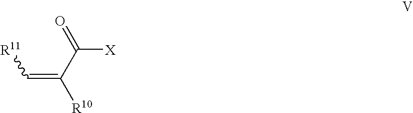

where

R¹⁰ is selected from
branched or unbranched C₁-C₁₀-alkyl, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethyihexyl, n-nonyl, n-decyl; more preferably C₁-C₄-alkyl such as methyl, ethyl, n-propyl, iso-propyl, n-butyl, iso-butyl, sec-butyl and tert-butyl;
or hydrogen;

most preferably hydrogen and methyl;

R¹¹ is selected from
branched or unbranched C₁-C₁₀-alkyl such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; more preferably C₁-C₄-alkyl such as methyl, ethyl, n-propyl, iso-propyl, n-butyl, iso-butyl, sec-butyl and tert-butyl;
or most preferably hydrogen.

X is selected from
—OH, —NH₂, —NH—CH₂OH.

Most preferably, in the formula V, R¹⁰ is selected from hydrogen and methyl and R¹¹ is hydrogen.

In a further embodiment of the present invention, step d) may be carried out using as comonomers from 1% to 14% by weight of (meth)acrylonitrile, based on the total amount of comonomers.

Other particularly suitable comonomers in step d) are comonomers which can serve as a photoinitiator, especially (meth)acrylic esters of alcohols which can serve as a photoinitiator of free-radical polymerizations. Very particular preference is given to optionally substituted (meth)acryloylbenzophenones of the general formula VII

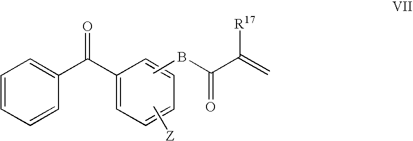

where Z is selected from hydrogen and hydroxyl,

B represents a spacer, for example oxygen, NH, —O-A⁷-O—, —OCO-A⁷-O—, —CO—NH-A⁷-O—, —CO—NH-A⁷-NH—, —O-A⁷-CO—NH-A⁷-NH,

A⁷ is at each occurrence the same or different and selected from C₂-C₃₀-alkylene, preferably C₂-C₆-alkylene, such as for example —(CH₂)₂—, —CH₂—CH(CH₃)—, —(CH₂)₃—, —CH₂—CH(C₂H₅)—, —(CH₂)₄—, —(CH₂)₅—, —(CH₂)₆—, 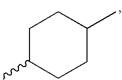
preferably C₂-C₄-alkylene; especially —(CH₂)₂—, —CH(C₂H₅)—, —CH₂—CH(CH₃)—, —(CH₂)₃—, —(CH₂)₄— and —CH₂—CH(C₂H₅)—;

and R¹⁷ is selected from
branched or unbranched C₁-C₁₀-alkyl, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl; more preferably C₁-C₄-alkyl such as methyl, ethyl, n-propyl, iso-propyl, n-butyl, iso-butyl, sec-butyl and tert-butyl;
or hydrogen;

hydrogen and methyl are most preferred.

Particular preference is given to comonomers of the formulae P1 to P6

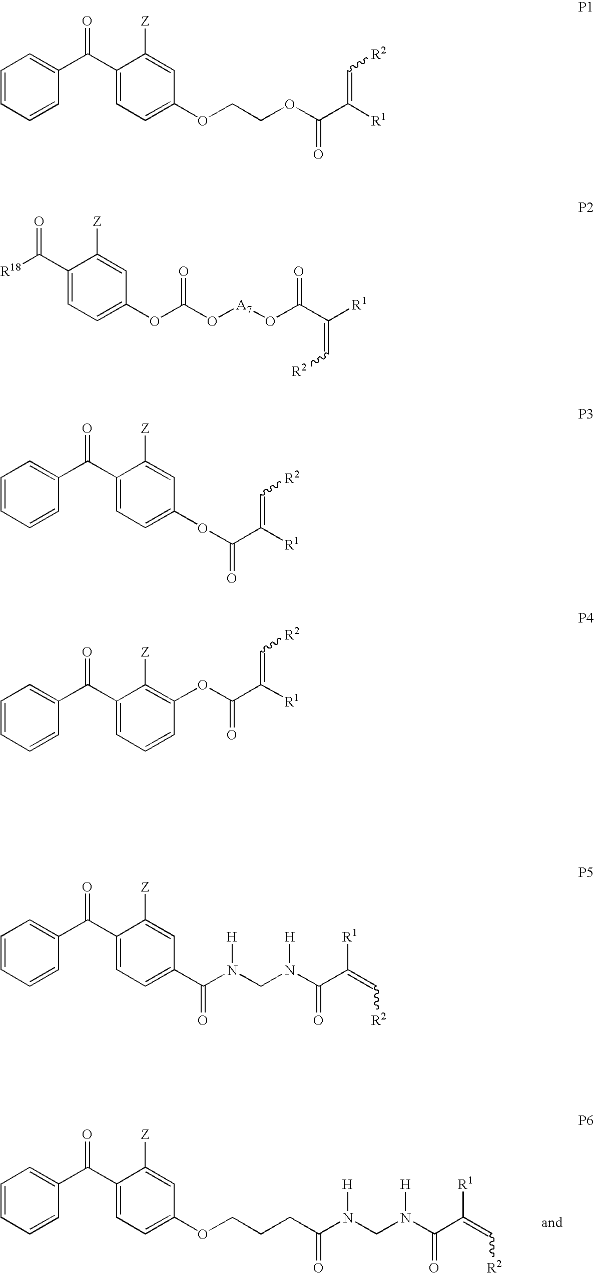

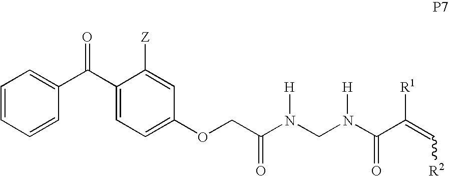

where
R¹⁸ is selected from C₁-C₄-alkyl such as methyl, ethyl, n-propyl, iso-propyl, n-butyl, 10 iso-butyl, sec-butyl and tert-butyl;
   and C₆-C₁₄-aryl, optionally substituted, such as phenyl, p-hydroxyphenyl, p-dimethylaminophenyl, p-methylphenyl, 1-naphthyl, 2-naphthyl, 9-anthryl, 1-anthryl, 2-anthryl, especially phenyl,

and the other variables are each as defined above.

Comonomers of the general formulae P1 to P4 are preparable by methods known per se. The preparation typically involves an esterification or transesterification of precursors of the formulae

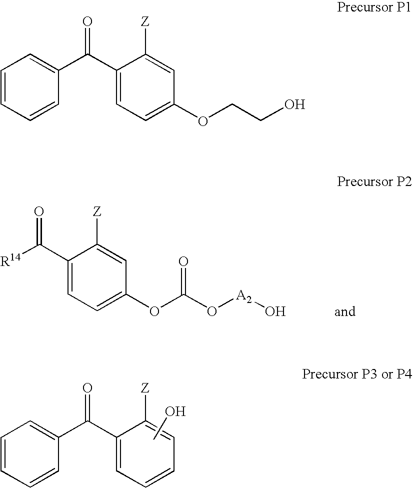

and with acids or esters of the formula

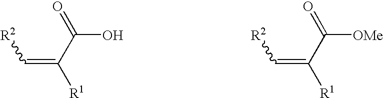

preferably in the presence of catalyst, Me being methyl and the variables in the formulae each being as defined above.

The effectiveness of photoinitiators can if desired be enhanced by addition of at least synergist, for example at least one amine and especially tertiary amine. Suitable amines are for example triethylamine, N,N-dimethylethanolamine, N-methylethanolamine, triethanolamine, aminoacrylates such as for example amine-modified polyether acrylates. Typically, it is possible to add up to 5% by weight of synergist, based on the total weight of the formulation of the present invention.

Step d) may be used to incorporate by copolymerization from 0.1% to 2% by weight and preferably from 0.2% to 1.5% by weight of units derived from at least one comonomer which may serve as a photoinitiator.

For instance, step d) may be used to incorporate by copolymerization from 0.1% to 2% by weight and preferably from 0.2% to 1.5% by weight of units derived from an isomeric mixture of VII.

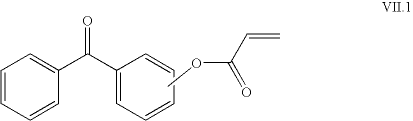

Formulations of the present invention are typically aqueous dispersions of pigment in particulate form that has been treated as described hereinabove, and may have a solids content in the range from 10% to 50% by weight and preferably in the range from 30% to 40% by weight.

Formulations of the present invention further comprise at least one radiation-curable component (B).

In one embodiment of the present invention, a formulation which is in accordance with the present invention comprises as a radiation-curable component at least one compound which bears at least two ethylenically unsaturated double bonds per molecule which are preferably isolated from each other, i.e., they are not conjugated. The radiation-curable component preferably comprises at least one compound which bears at least two (meth)acrylic acid groups, for example at least doubly (meth)acrylated di- or polycarboxylic acids, or di- or polyisocyanates which have been reacted at least twice with functional (meth)acrylic acid derivatives and which hereinafter will also be referred to as urethane (meth)acrylates. Very particular preference is given to compounds of the general formula VI a, VI b or VI d

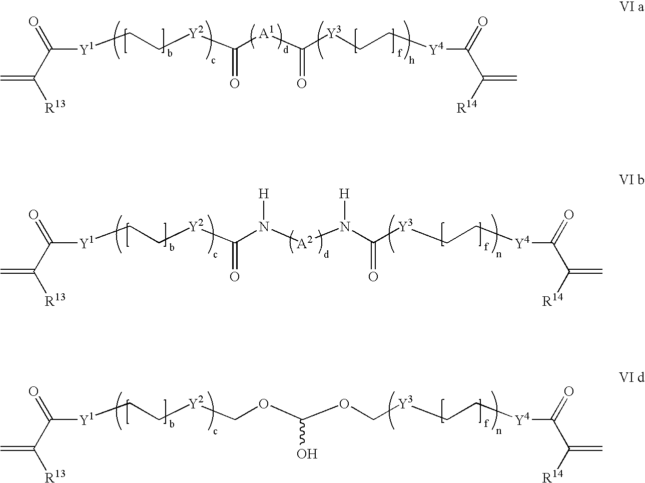

where
R¹³, R¹⁴ are different or preferably the same and are each selected from hydrogen and methyl,
Y¹, Y², Y³, Y⁴ are the same or different and each selected from sulfur, N—H and especially oxygen,
A¹, A² are divalent units selected from
   C₁-C₁₀-alkylene, substituted or unsubstituted, such as for example —CH₂—, —CH(CH₃)—, —CH(C₂H₅)—, —CH(C₆H₅)—, —(CH₂)₂—, —(CH₂)₃—, —(CH₂)₄—, —(CH₂)₅—, —(CH₂)₆—, —(CH₂)₇—, —CH(CH₃)—(CH₂)₂—CH(CH₃)—;
   cis- or trans-C₄-C₁₀-cycloalkylene, such as for example cis-1,3-cyclopentylidene, trans-1,3-cyclopentylidene, cis-1,4-cyclohexylidene, trans-1,4-cyclohexylidene; and
   C₆-C₁₄-arylene, such as for example meta-phenylene, para-phenylene, 2,7-naphthylidene;

although in the formula VI a the Al variable may also represent a single bond;
b, f are integers, different or preferably the same, in the range from 2 to 10 and preferably in the range from 2 to 4;
c, h are integers, different or preferably the same, in the range from 1 to 10 and preferably in the range from 1 to 3;
d is an integer in the range from 1 to 5 and more preferably 1.

Preferably, b and f are the same, c and h are the same, Y¹ and Y⁴ are the same, Y² and Y³ are the same and R¹³ and R¹⁴ are the same.

Very particular preference is given to

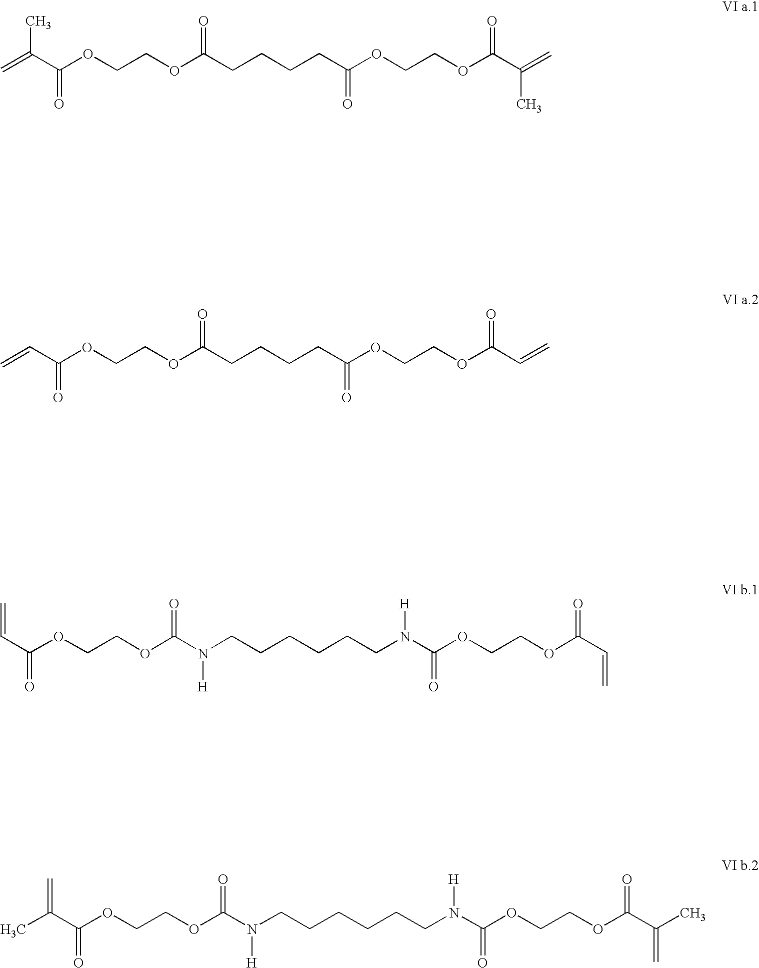

Other suitable compounds which bear at least two ethylenically unsaturated bonds per molecule are compounds of the general formula VI c

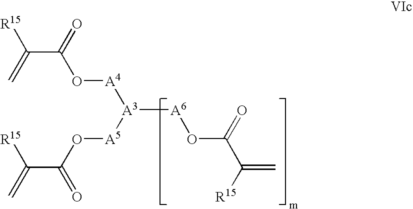

where

R¹⁵ is at each instance the same or different and selected from methyl and hydrogen;

m is an integer from 0 to 2, preferably 1;

A³ is CH₂ or —CH₂—CH₂— or R¹⁶—CH or para-C₆H₄ when m=0,
CH, R¹⁶—C or 1,3,5-C₆H₃ when m=1,
and carbon when m=2;

R¹⁶ is selected from C₁-C₄-alkyl, such as for example n-C₄H₉, n-C₃H₇, iso-C₃H₇ and
preferably C₂H₅ and CH₃,
or phenyl,

A⁴, A⁵, A⁶ are the same or different and each is selected from
C₁-C₂₀-alkylene, such as for example —CH₂—, —CH(CH₃)—, —CH(C₂H₅)—, —CH(C₆H₅)—, —(CH₂)₂—, —(CH₂)₃—, —(CH₂)₄—, —(CH₂)₅—, —(CH₂)₆—, —(CH₂)₇—, —(CH₂)₈—, —(CH₂)₉—, —(CH₂)₁₀—, —CH(CH₃)—(CH₂)₂—CH(CH₃)—;
cis- or trans-C₄-C₁₀-cycloalkylene, such as for example cis-1,3-cyclopentylidene, trans-1,3-cyclopentylidene cis-1,4-cyclohexylidene, trans-1,4-cyclohexylidene;
C₁-C₂₀-alkylene in which from one to seven nonadjacent carbon atoms are replaced by oxygen such as for example —CH₂—O—CH₂—, —(CH₂)₂—O—CH₂—, —(CH₂)₂O—(CH₂)₂—, —[(CH₂)₂—O]₂—(CH₂)₂—, —[(CH₂)₂—O]₃—(CH₂)₂;
C₁-C₂₀-alkylene substituted with up to 4 hydroxyl groups, wherein from one to seven nonadjacent carbon atoms in C₁-C₂₀-alkylene are replaced by oxygen, such as for example —CH₂—O—CH₂—CH(OH)—CH₂—, —CH₂—O—[CH₂—CH(OH)—CH₂]₂—, —CH₂—O—[CH₂—CH(OH)—CH₂]₃-;

C₆-C₁₄-arylene, such as for example para-C₆H₄.

Other preferred examples of branched compounds having at least two terminal double bonds are polyester (meth)acrylates obtainable by for example reaction of hydroxyl-terminated polyesters having a molecular weight M, preferably in the range from 250 to 4000 g/mol or polyethers having a molecular weight Mₙ in the range from 400 to 4000 g/mol with (meth)acrylic acid as described for example in EP-B 0 126 341.

Other preferred examples of branched compounds having at least two terminal double bonds are (meth)acrylate urethanes, preferably available as aqueous dispersions, which are preparable by reaction of polyester (meth)acrylates with preferably aromatic di- or triisocyanates as described for example in WO 98/47975.

Formulations in accordance with the present invention may comprise from 0.2% to 30% by weight and preferably from 1% to 15% by weight of a radiation-curable component (B).

In a specific embodiment of the present invention, formulations in accordance with the present invention comprise at least one radiation-curable component in the form of moieties. This specific embodiment can be actualized for example by employing in step d) of the treatment of the pigment or pigments in particulate form selected comonomers which bear suitable moieties for radiative curing to be carried out. Suitable comonomers are in particular crosslinking-capable comonomers which bear at least two ethylenically unsaturated double bonds per molecule which are preferably isolated from each other, i.e., they are not conjugated. Preferably there is at least one comonomer which bears at least two (meth)acrylic acid groups, for example at least doubly methacrylated di- or polycarboxylic acids or urethane (meth)acrylates. Very particular preference is given to compounds of the general formula VI a or VI b as defined above.

In a further embodiment of the present invention, the formulations of the present invention comprise filming assistants.

In a further embodiment, the radiation-curable component or components (B) or alternatively the filming assistant can be used to additionally introduce one or more unpolymerized photoinitiators into the pigment-polymer system.

Formulations in accordance with the present invention may comprise polymer or copolymer derived from step d) monomers or mixtures of comonomers. The majority of pigments in particulate form which have been treated according to the process described above are coated by two polymer or copolymer layers, which may be interpenetrating and need not be strictly divorced from each other. The particles thus characterized will hereinafter also be referred to as pigment-containing polymer particles.

In a preferred embodiment of the present invention, formulations which are in accordance with the present invention comprise polymer or copolymer derived from step d) monomers or mixtures of comonomers. The polymer or copolymer derived respectively from step d) monomers and mixtures of comonomers is preferably obtained in the form of spherical particles. The particles thus characterized are hereinafter also referred to as pigment-free polymer particles.

In a preferred embodiment, the weight ratio of pigment-containing polymer particles to pigment-free polymer particles is in the range from 10:0.1 to 10:3 and preferably in the range from 10:0.5 to 10:2.

In a preferred embodiment, the average radii r of pigment-free polymer particles are smaller than the average radii r of pigment-containing polymer particles, each based on the number average. The radii ratio

$$\frac{r ( pigment \text{-} containing polymer particles )}{r ( pigment \text{-} free polymer particles )}$$

may be for example in the range from 1.2 to 10 and preferably in the range from 2 to 5.

In one embodiment of the present invention, formulations which are in accordance with the present invention have at least one plasticizer (C) added to them following step d).

Preferably, plasticizer (C) is liquid under standard conditions (1 atm, 20° C.).

Examples of plasticizers (C) are ester compounds selected from the group consisting of fully alkanol-esterified aliphatic or aromatic di- or polycarboxylic acids and at least singly alkanol-esterified phosphoric acid.

Alkanol is C₁-C₁₀-alkanol in one embodiment of the present invention.

Preferred examples of fully alkanol-esterified aromatic di- or polycarboxylic acids are fully alkanol-esterified phthalic acid, isophthalic acid and mellitic acid; particular examples are: di-n-octyl phthalate, di-n-nonyl phthalate, di-n-decyl phthalate, di-n-octyl isophthalate, di-n-nonyl isophthalate, di-n-decyl isophthalate.

Preferred examples of fully alkanol-esterified aliphatic di- or polycarboxylic acids are for example dimethyl adipate, diethyl adipate, di-n-butyl adipate, diisobutyl adipate, dimethyl glutarate, diethyl glutarate, di-n-butyl glutarate, diisobutyl glutarate, dimethyl succinate, diethyl succinate, di-n-butyl succinate, diisobutyl succinate and also mixtures thereof.

Preferred examples of at least singly alkanol-esterified phosphoric acid are C₁-C₁₀-alkyl di-C₆-C₁₄-aryl phosphates such as isodecyl diphenyl phosphate.

Further examples of plasticizers (C) are at least singly C₁-C₁₀-alkyl-carboxylated aliphatic or aromatic di- or polyols.

A preferred example of at least singly C₁-C₁₀-alkyl-carboxylated aliphatic or aromatic di- or polyols is 2,2,4-trimethylpentane-1,3-diol monoisobutyrate.

Further suitable plasticizers (C) are polyesters obtainable by polycondensation of aliphatic dicarboxylic acid and aliphatic diol, for example adipic acid or succinic acid and 1,2-propanediol, preferably having an M_{w} of 200 g/mol, and polypropylene glycol alkylphenyl ether, preferably having an M_{w} of 450 g/mol.

Further suitable plasticizers (C) are polypropylene glycols etherified with two different alcohols and having a molecular weight M_{w} in the range from 400 to 800 g/mol, wherein preferably one of the alcohols may be an alkanol, especially a C₁-C₁₀-alkanol, and the other alcohol may preferably be an aromatic alcohol, for example o-cresol, m-cresol, p-cresol and especially phenol.

The present invention further provides for the use of the formulations of the present invention for coloration of substrates. The present invention further provides a process for coloration of substrates using the formulations of the present invention, hereinafter also referred to as inventive coloration process, and also colored substrates obtainable by an inventive coloration process.

In one embodiment of the present invention, the inventive coloration process is carried out by substrates being contacted with pigment in particulate form that has been treated in accordance with the present invention and thereafter exposed to actinic radiation. The actinic radiation used may be for example electromagnetic rays having a wavelength range from 200 nm to 450 nm. Substrates contacted with pigment in particulate form that has been treated in accordance with the present invention can be exposed to actinic radiation having an energy in the range from 70 mJ/cm² to 1500 mJ/cm². Actinic radiation can be introduced for example continuously or in the form of flashes. When benzophenone derivatives, for example of the formula P1 or P3 to P7, have been incorporated through copolymerization in step d), a fraction of UV-C radiation of 250-260 nm wavelength is important in order that crosslinking may occur via the benzophenone group.

Substrates for the purposes of the present invention are for example
cellulosic materials such as paper, paperboard, cardboard, wood and woodbase, which may each be lacquered or otherwise coated,
metallic materials such as foils, sheets or workpieces composed of aluminum, iron, copper, silver, gold, zinc or alloys thereof, which may each be lacquered or otherwise coated,
silicatic materials such as glass, porcelain and ceramic, which may each be coated,
polymeric materials of any kind such as polystyrene, polyamides, polyesters, polyethylene, polypropylene, melamine resins, polyacrylates, polyacrylonitrile, polyurethanes, polycarbonates, polyvinyl chloride, polyvinyl alcohols, polyvinyl acetates, polyvinylpyrrolidones and corresponding copolymers including block copolymers, biodegradable polymers and natural polymers such as gelatin,
comestibles and cosmetics

and especially leather and textiles or textile substrates.

Leather for the purposes of the present invention is to be understood as meaning pretanned, tanned and if appropriate retanned leather or correspondingly processed synthetic replacement material, which may have already been treated with at least one dye during at least one tanning step. Leather in the realm of the present invention may have already been hydrophobicized or fatliquored.

Textiles and textile substrates for the purposes of the present invention are textile fibers, textile intermediate and end products and finished articles manufactured therefrom which, as well as textiles for the apparel industry, also comprise for example carpets and other home textiles and also textile structures for industrial purposes. These also include unshaped structures such as for example staples, linear structures such as twine, filaments, yarns, lines, strings, laces, braids, cordage, threads and also three-dimensional structures such as for example felts, wovens, nonwovens and waddings. Textiles can be of natural origin, for example cotton, wool or flax, or synthetic, for example polyamide, polyester, modified polyester, polyester blend fabric, polyamide blend fabric, polyacrylonitrile, viscose, triacetate, acetate, polycarbonate, polypropylene, polyvinyl chloride, polyester microfibers and glass fiber fabric.

In one embodiment of the present invention, the inventive process for coloration of substrates is an inventive process for printing substrates by the ink jet process.

The present invention further provides for the use of formulations which are in accordance with the present invention as or for producing inks for the ink jet process. The present invention further provides a process for producing inks for the ink jet process using formulations which are in accordance with the present invention. The present invention further provides inks for the ink jet process which have been produced using formulations which are in accordance with the present invention. Ink jet process inks which are in accordance with the present invention may be produced using the formulations of the present invention as such and also the pigments which have been treated in accordance with the present invention and which have been separated from the dispersions of the present invention.

Ink jet process inks in accordance with the present invention are particularly easy to produce by formulations which are in accordance with the present invention being diluted with, for example, water and if appropriate admixed with additives.

In a preferred embodiment of the present invention, an inventive ink for the ink jet process comprises from 1 to 50 g/100 ml, and preferably from 1.5 to 15 g/100 ml of inventively treated pigment in particulate form.

Additives for inclusion in inventive colorant preparations and especially inventive inks for the ink jet process comprise organic solvents. Low molecular weight polytetrahydrofuran is a preferred additive, it may be used alone or preferably mixed with one or more high-boiling water-soluble or water-miscible organic solvents.

The preferably used low molecular weight polytetrahydrofuran customarily has an average molecular weight M_{w} from 150 to 500 g/mol, preferably from 200 to 300 g/mol and more preferably of about 250 g/mol (as corresponds to a molecular weight distribution).

Polytetrahydrofuran is preparable in a known manner via cationic polymerization of tetrahydrofuran. The products are linear polytetramethylene glycols.

When polytetrahydrofuran mixed with further organic solvents is used as an additive, the solvents used for this purpose are generally high boiling (i.e., generally have a boiling point >100° C. at atmospheric pressure) and hence water-retaining organic solvents which are soluble in or miscible with water.

Useful solvents include polyhydric alcohols, preferably unbranched and branched polyhydric alcohols having from 2 to 8 and especially from 3 to 6 carbon atoms, such as ethylene glycol, 1,2-propylene glycol, 1,3-propylene glycol, glycerol, erythritol, pentaerythritol, pentitols such as arabitol, adonitol and xylitol and hexitols such as sorbitol, mannitol and dulcitol.

Useful solvents further include polyethylene glycols and polypropylene glycols (which is also to be understood as meaning the lower polymers (di-, tri- and tetramers)) and their mono (especially C₁-C₆, in particular C₁-C₄) alkyl ethers. Preference is given to polyethylene and polypropylene glycols having average molecular weights of from 100 to 1500 g/mol, in particular from 200 to 800 g/mol, mainly from 300 to 500 g/mol. Examples are diethylene glycol, triethylene glycol, tetraethylene glycol, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, di-, tri- and tetra-1,2- and -1,3-propylene glycol and di-, tri- and tetra-1,2- and -1,3-propylene glycol monomethyl, monoethyl, monopropyl and monobutyl ether.

Useful solvents further include pyrrolidone and N-alkylpyrrolidones whose alkyl chain preferably comprises from 1 to 4, especially 1 or 2, carbon atoms. Examples of useful alkylpyrrolidones are N-methylpyrrolidone, N-ethylpyrrolidone and N-(2-hydroxyethyl)-pyrrolidone.

Examples of particularly preferred solvents are 1,2-propylene glycol, 1,3-propylene glycol, glycerol, sorbitol, diethylene glycol, polyethylene glycol (M_{w} from 300 to 500 g/mol), diethylene glycol monobutyl ether, triethylene glycol monobutyl ether, pyrrolidone, N-methylpyrrolidone and N-(2-hydroxyethyl)pyrrolidone.

Polytetrahydrofuran may also be mixed with one or more (e.g., two, three or four) of the abovementioned solvents.

In one embodiment of the present invention, the inventive inks for the ink jet process may comprise from 0.1 to 80% by weight, preferably from 5% to 60% by weight, more preferably from 10% to 50% by weight and most preferably from 10% to 30% by weight of nonaqueous solvents.

Nonaqueous solvent additives, including especially the particularly preferred solvent combinations mentioned, may advantageously be augmented with urea (generally from 0.5% to 3% by weight, based on the weight of the colorant preparation) to further enhance the water-retaining effect of the solvent mixture.

The inventive inks for the ink jet process may comprise further assistants of the type which are customary especially for aqueous ink jet inks and in the printing and coatings industry. Examples of such assistants are preservatives such as for example 1,2-benzisothiazolin-3-one (commercially available as Proxel brands from Avecia Lim.) and its alkali metal salts, glutaraldehyde and/or tetramethylolacetylenediurea, Protectols®, antioxidants, degasers/defoamers such as for example acetylenediols and ethoxylated acetylenediols, which customarily comprise from 20 to 40 mol of ethylene oxide per mole of acetylenediol and also may have a dispersing effect, agents for regulating the viscosity, flow assistants, wetting agents (for example wetting surfactants based on ethoxylated or propoxylated fatty or oxo alcohols, propylene oxide-ethylene oxide block copolymers, ethoxylates of oleic acid or alkylphenols, alkylphenol ether sulfates, alkylpolyglycosides, alkyl phosphonates, alkylphenyl phosphonates, alkyl phosphates, alkylphenyl phosphates or preferably polyethersiloxane copolymers, especially alkoxylated 2-(3-hydroxypropyl)heptamethyltrisiloxanes, which generally have a block of 7 to 20 and preferably 7 to 12 ethylene oxide units and a block of 2 to 20 and preferably 2 to 10 propylene oxide units and may be comprised in the colorant preparations in amounts from 0.05% to 1% by weight), antisettling agents, luster improvers, lubricants, adhesion promoters, antiskinning agents, delusterants, emulsifiers, stabilizers, hydrophobicizers, light control additives, hand improvers, antistats, bases such as for example triethanolamine or acids, specifically carboxylic acids such as for example lactic acid or citric acid for regulating the pH. When these agents are part of inventive colorant preparations and especially inventive inks for the ink jet process, their total amount will generally be 2% by weight and especially 1% by weight, based on the weight of the inventive colorant preparations and especially of the inventive inks for the ink jet process.

In one embodiment of the present invention, the inventive inks for the ink jet process have a dynamic viscosity in the range from 2 to 80 mPa·s and preferably in the range from 3 to 20 mPa·s, measured at 25° C.

The surface tension of inventive inks for the ink jet process is generally in the range from 24 to 70 mN/m and especially in the range from 25 to 60 mN/m, measured at 25° C.

The pH of inventive inks for the ink jet process is generally in the range from 5 to 10 and preferably in the range from 7 to 9.

A further aspect of the present invention is a process for printing sheetlike or three-dimensional substrates by the ink jet process using the ink jet process inks of the present invention. To this end, ink jet inks which are in accordance with the present invention are printed onto substrate and the print obtained is subsequently fixed by radiative curing.

In the ink jet process, the typically aqueous inks are sprayed as small droplets directly onto the substrate. There is a continuous form of the process, in which the ink is pressed at a uniform rate through a nozzle and the jet is directed onto the substrate by an electric field depending on the pattern to be printed, and there is an interrupted or drop-on-demand process, in which the ink is expelled only where a colored dot is to appear, the latter form of the process employing either a piezoelectric crystal or a heated hollow needle (bubble or thermal jet process) to exert pressure on the ink and so eject an ink droplet. These techniques are described in Text. Chem. Color 19 (1987), No. 8, 23-29, and 21 (1989), No. 6, 27-32.

The inventive inks are particularly suitable for the bubble jet process and for the process employing a piezoelectric crystal.

In a specific embodiment of the present invention, the process for coloration of textile substrates which is in accordance with the present invention is an inventive process for textile printing.

Formulations described above are used according to the present invention to produce dyeing liquors for pigment dyeing or print pastes for pigment printing, specifically for textile pigment printing. The present invention thus further provides a process for producing dyeing liquors for pigment dyeing and for producing print pastes for pigment printing and also the inventive dyeing liquors and print pastes, hereinafter also referred to as inventive production process.

The inventive production process comprises mixing at least one inventive dispersion with assistants required for the dyeing or printing operation and adjusting the colorant content by diluting with water.

The water used for practicing the inventive production process need not be completely ion-free. It is customary to use incompletely deionized water or very soft water, for example with 4° or less of German hardness. If insufficiently soft water is available, it is customary to use complexing agents (water softeners) to control the hardness in the water. Useful water softeners for the pigment dyeing operation generally sequester Ca²⁺ and Mg²⁺ ions. Examples of particularly useful water softeners are nitrilotriacetic acid, ethylenediaminetetraacetic acid, diethylenetriaminepentaacetic acid, hydroxyethylethylenediaminetriacetic acid or methylglycinediacetic acid. The amount of water added to produce the dyeing liquor depends on the depth of shade to be produced on the textile on the one hand and on the amount of dyeing liquor padded onto the textile on the other.

Inventive dyeing liquors may further comprise additives. Preferred additives are organic solvents in concentrations from 0% to 10% by weight and preferably from 0.1% to 5% by weight. Useful solvents include for example polyethylene glycols and singly etherified alkylene glycol or singly etherified polyethylene glycols such as for example diethylene glycol mono-n-butyl ether.

Inventive dyeing liquors may further comprise a wetting agent additive, preferably a wetting agent of the low-foam type, since foaming generally due to the high turbulence of the dyeing operation may impair the quality of the dyeing by producing unlevelness. Wetting agents used include for example: ethoxylated and/or propoxylated products of fatty alcohols or propylene oxide-ethylene oxide block copolymers, ethoxylated or propoxylated fatty or oxo alcohols, also ethoxylates of oleic acid or alkylphenols, alkylphenol ether sulfates, alkylpolyglycosides, alkyl phosphonates, alkylphenyl phosphonates, alkyl phosphates and alkylphenyl phosphates.

Dry woven or loop-formingly knitted textiles as used in continuous pigment dyeing comprise a large amount of air. Dyeing here requires the use of deaerators. These are based for example on polyether siloxane copolymers or on phosphoric esters. They can be comprised in the inventive dyeing liquors in amounts from 0.01 to 2 g/l.

Inventive dyeing liquors may further include one or more hand improvers. These are generally polysiloxanes or waxes based on polyethylene or polyethylene glycol. Polysiloxanes have the advantage of permanence, whereas some waxes may be gradually washed off during use. In one embodiment of the present invention, however, no hand improver is included.

In one embodiment of the present invention, the dynamic viscosity of the inventive dyeing liquors is in the range below 100 mPa·s, measured at 20° C. The surface tensions of the inventive dyeing liquors are to be adjusted so as to enable fabric wetting. Surface tensions of less than 50 mN/m, as measured at 20° C., are suitable.

A further aspect of the present invention is a process for producing the inventive dyeing liquors. The inventive production process typically comprises mixing at least one inventive formulation with one or more of the above-recited additives such as solvents, defoamers, hand improvers, emulsifiers and/or biocides and making up with water. The process customarily -comprises the components being stirred in a mixing vessel, the size and shape of which are not critical. The stirring is preferably followed by a clarifying filtration.

A further aspect of the present invention is a process for dyeing textile substrates using the above-described inventive dyeing liquors. The process can be carried out in the usual machines. Preference is given to pad-mangles comprising essentially two nip rolls through which the textile is led. The liquid sits above the rolls and wets the textile. The nip pressure causes the textile to be squeezed off and ensures a constant add-on.

In a further embodiment, the textile is led over a deflecting roller and through a trough holding the dyeing liquor. A pair of rolls which is disposed above the liquor is then used to squeeze off excess liquor to ensure a constant add-on.

The actual dyeing step is customarily followed by a thermal drying and fixation, preferably by drying at from 50 to 90° C. for from 30 seconds to 3 minutes and then fixing using actinic radiation. Preference is given to a process for pigment dyeing by padding. The printed and dyed substrates are notable for particular brilliance of color coupled with outstanding hand. A further aspect of the present invention accordingly relates to substrates dyed by the above-described process using the inventive dyeing liquors.

A further aspect of the present invention is the use of inventive formulations for textile printing. The invention provides that at least one inventive formulation be for this purpose incorporated in a print paste. Advantageously, the inventive print paste for textile printing is produced from at least one inventive formulation by mixing with customary printing process assistants and then adjusting the colorant content by diluting with water.

Commonly used assistants are known from Ullmann, Handbuch der technischen Chemie und Verfahrenstechnik, cf. for example Ullmann's Enyclopedia of Industral Chemistry, 5th edition, Textile Auxiliaries, vol. A26, p. 286 ff. and 296 ff., Verlag Chemie, Weinheim, Deerfield/Fla., Basle; 1996. Examples of commonly used assistants are thickeners, hand improvers and emulsifiers.

Natural and synthetic thickeners can be used. Preference is given to the use of synthetic thickeners, for example generally liquid solutions of synthetic polymers in for example white oil or as aqueous solutions.

Inventive print pastes may further comprise hand improvers, which are typically selected from silicones, especially polydimethylsiloxanes, and fatty acid esters. Examples of commercially available hand improvers useful for inclusion in the inventive print pastes are Acramin® Weichmacher SI (Bayer AG), Luprimol SIG® and Luprimol CW®) (BASF Aktiengesellschaft).

Inventive print pastes may further include one or more emulsifiers, especially when the pastes comprise thickeners containing white oil and are obtained as an oil-in-water emulsion. Examples of suitable emulsifiers include aryl- or alkyl-substituted polyglycol ethers. Commercially available examples of suitable emulsifiers are Emulgator W® (Bayer), Luprintol PE New® and Luprintol MP® (BASF Aktiengesellschaft), and Solegal W® (Hoechst AG).

Pigment printing using at least one inventive formulation can be carried out by various processes known per se. It is customary to use a screen through which the print paste is forced with a squeegee. This process belongs to the screen printing processes. The inventive pigment printing process utilizing the inventive print pastes provides printed substrates combining particularly high brilliance and depth of shade for the prints with excellent hand for the printed substrates. The present invention accordingly also provides substrates printed by the inventive process using the inventive print pastes.

In a specific embodiment of the present invention, the inventive coloration process is a process for finishing leather. The purpose of finishing/coating leather is to endow leather with a desired appearance, specific haptic properties and also service fastnesses, such as for example flex elasticity, wet and dry rub fastness, perspiration resistance and water fastness.

In one embodiment, the inventive coloration process proceeds from pretanned, tanned and if appropriate retanned leather which may already be hydrophobicized and dyed in a conventional manner.

The initial step is to apply at least one colored finishing dispersion, comprising one or more inventively treated pigments in particulate form in an amount of 20 to 100 g of solids per m² of leather surface area to the leather to be colored. Application may be accomplished by conventional methods, for example by plushing, i.e., application with sponge or brushlike apparatus which may be covered with plush or velvet fabric, by brushing, roll coating, casting, spraying or atomizing. The leather thus treated may subsequently be dried, for example at a temperature in the range from 30 to 120° C., preferably 60 to 80° C. The application of at least one colored finishing dispersion may take place in one or more steps, which may be carried out identically or differently and may each be interrupted by an intervening drying at the abovementioned temperatures.

In a preferred embodiment of the present invention, a colored finishing dispersion used in accordance with the present invention comprises at least one formulation which is in accordance with the present invention.

Colored finishing dispersions used in accordance with the present invention, hereinafter also referred to as inventive colored finishing dispersions, are typically aqueous. They may comprise further, nonaqueous solvents such as for example ethylene glycol, N-methylpyrrolidone, 3-methoxypropanol and propylene carbonate. In a preferred embodiment, inventive bottoming dispersions comprise the following constituents:

α1) at least one inventive formulation, preferably 20 to 70% by weight, based on the total weight of inventive colored finishing dispersion;

β1) optionally at least one wax, such as for example oxidized polyethylene wax or montan wax, preferably 1 to 15% by weight based on the total weight of inventive colored finishing dispersion;

γ1) optionally at least one biocide, for example 1,2-benzisothiazolin-3-one (“BIT”) (commercially available as Proxel® brands from Avecia Lim.) and its alkali metal salts; other suitable biocides are 2-methyl-2H-isothiazole-3 (“MIT”) and 5-chloro-2-methyl-2H-isothiazol-3-one (“CIT”). In general, 10 to 150 ppm of biocide based on bottoming dispersion are sufficient.

Inventive colored finishing dispersions may further comprise at least one filling and antiadhesive agent. Suitable are for example aqueous formulations of fatty acid ester, albumen and inorganic filler which may be selected from silicates and clay minerals.

Inventive colored finishing dispersions may have a solids content of 10 to 80% by weight, preference being given to 20 to 50% by weight.

A pigment coat may subsequently be applied in a conventional manner. The pigment coat may consist of customary constituents.

In one embodiment of the present invention, the pigment coat comprises

α2) at least one inventive formulation, preferably 20 to 70% by weight, based on the total weight of inventive pigment coat,

β2) at least one wax, such as for example oxidized polyethylene wax or montan wax or silicone wax, preferably 1 to 15% by weight, based on the total weight of inventive pigment coat;

γ2) optionally at least one biocide, for example selected from MIT, BIT and CIT, for example in the amounts mentioned for bottoming dispersions,

δ2) optionally at least one pigment in particulate form,

ε2) optionally at least one thickener.

Seasoning may subsequently be applied in the form of a seasoning dispersion, at about 5 to 30 g/m² of leather surface area. The seasoning or top coat serves to protect the leather and shall ensure not only high flexibility but also good scratch resistance, oil resistance and water resistance. Depending on the desired article, it shall be lustrous or matte, i.e., matting agents or delusterants may also be added. Seasonings may comprise for example: formulations composed of at least one binder based on acrylate or polyurethane, a wetting agent, albumen, nitrocellulose emulsion, fillers based on organic or inorganic delusterants, silicone wax, fatty acid ester.

Inventive seasoning dispersions may comprise known polyurethane dispersions prepared according to EP-A2 0 392 352.

Pigment coats and seasoning dispersions may comprise one or more thickeners. Examples are crosslinkable copolymers based on acrylic acid and acrylamide and also thickeners based on polyurethane or polyvinylpyrrolidone or acrylate (co)polymers.

Application of the seasoning may be followed by drying under customary conditions, for example at temperatures in the range from 60 to 80° C., and subsequent hot pressing, for example at temperatures in the range from 140 to 180° C. It is also possible to hot press hydraulically, for example at reduced pressure and temperatures in the range from 70 to 100° C. Conventional apparatuses for ironing are contemplated, such as for example ironing presses or continuous pressing machines.

The inventive process for finishing leather utilizes at least one inventive formulation and at least one step—bottoming, pigment coating and seasoning.

Top coating (seasoning) dispersions may comprise one or more thickeners. Examples are crosslinkable copolymers based on acrylic acid and acrylamide. Preferred examples are copolymers with 85 to 95% by weight of acrylic acid, 4 to 14% by weight of acrylamide and about 1% by weight of (meth)acrylamide derivative of the formula VIII

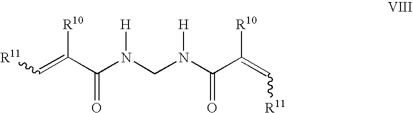

having molecular weights M_{w} in the range from 100 000 to 200 000 g/mol, in each of which the R¹⁰ and R¹¹ radicals may be the same or different and are each as defined above.

The present invention further provides colored substrates obtainable according to the coloration process of the present invention. Colored substrates in accordance with the present invention are notable for good wet rub fastnesses and can be produced even in deep shades at a very good crosslinking yield (quantum yield) of photoinitiators.

The present invention further provides pigments in particulate form which have been treated according to a process which comprises steps of:
(a) mixing pigment in particulate form with at least one nonionic surface-active substance,
(b) dispersing the thus obtainable mixture of pigment in particulate form and nonionic surface-active substance in an aqueous medium,
(c) addition polymerizing at least one first monomer or addition copolymerizing a first mixture of comonomers in the presence of a dispersion according to b) to form water-insoluble polymer or copolymer on the surface of the pigments in particulate form,
(d) adding a second mixture of comonomers and addition copolymerizing,

wherein said second mixture of comonomers comprises at least one comonomer which bears moieties useful for radiative curing.

Suitable comonomers are in particular crosslinking-capable comonomers which bear at least two ethylenically unsaturated double bonds per molecule which are preferably isolated from each other, i.e., they are not conjugated. Preferably there is at least one comonomer which bears at least two (meth)acrylic acid groups, for example at least doubly methacrylated di- or polycarboxylic acids or urethane (meth)acrylates. Very particular preference is given to compounds of the general formula VI a or VI b as defined above.

Other particularly suitable comonomers in step d) are comonomers which can serve as a photoinitiator, especially (meth)acrylic esters of alcohols which can serve as a photoinitiator of free-radical polymerizations. Very particular preference is given to (meth)acryloylbenzophenones of the general formula VII and which are as defined above.

Working examples illustrate the invention.

General preliminary remarks:

The glass transition temperature was determined using a Mettler Toledo TA8200 series DSC822 differential scanning colorimeter with TSO 801RO sample robot. The differential scanning calorimeter was equipped with an FSR5 temperature sensor.

Working was in accordance with German standard specification DIN 53765.

Evaluation was based on the second heating curve in each case. Cool in each case down to −110° C., heating rate: 20° C./min, heat up to 150° C., maintain at 150° C. for 5 minutes, then cool down to −110° C., heating rate: 20° C./min, heat up to 150° C.

The particle diameter distribution of pigments in particulate form which have been treated in accordance with the present invention was determined in accordance with ISO 13321 using a Malvern IIC Autosizer.

### EXAMPLE 1

1 a) Mixing a pigment with a nonionic surface-active substance

A stirred ball mill was used to grind together:

1800 g of Pigment Blue 15:3
450 g of n-C₁₈H₃₇O(CH₂CH₂O)₂₅H
24 g of glutardialdehyde
30 g of tetramethylolacetylenediurea

3696 g of distilled water

Grinding was continued until the pigment particles had an average diameter of 100 nm.

A mixture of pigment in particulate form and nonionic surface-active substance was obtained.

n-C₁₈H₃₇O(CH₂CH₂O)₂₅H is octadecanol ethoxylate prepared in accordance with the following prescription:

242 g of stearyl alcohol and 0.1 mol of KOH chips were dewatered in an autoclave at 100° C. and a pressure of 1 mbar in the course of 2 hours, then depressurized with nitrogen and purged 3 times with nitrogen and then heated to 130° C. in the autoclave. On 130° C. having been reached, the continuous addition commenced of 1100 g of ethylene oxide and continued for 3 h 20 min, at a pressure of up to 6.1 bar. On completion of the addition the reaction was allowed to continue until a constant pressure was reached. This was followed by cooling down to 1 00° C. and degassing in the autoclave at 1 mbar for 60 min before the reaction product was removed at 70° C. The yield was 1337 g.

1 b) Dispersing the mixture from 1 a) in water

267 g of the mixture from 1 a) were dispersed with 300 g of distilled water by stirring in a 1.5 liter tank equipped with stirrer, nitrogen feed and three metering means.

This gave a dispersion of pigment particles in an aqueous medium.

1 c) Polymerization

To the dispersion from 1 b) were added 7.0 g of 28% by weight sodium lauryl sulfate as an aqueous solution and 40 g of styrene and a pH of 4.0 was set with formic acid.

Nitrogen was then passed through the dispersion for 15 minutes. The dispersion was then heated to 85° C. Thereafter, 0.3 g of tert-butyl hydroperoxide (70% by weight in water) and 0.2 g of HO—CH₂—SO₂Na were added.

The formation of a water-insoluble polymer on the pigment in particulate form was observed.

1 d) Adding a comonomer emulsion and further copolymerization

10 minutes after the addition of tert-butyl hydroperoxide and HO—CH₂—SO₂Na from step 1 c) an emulsion of the following composition was added over a period of 135 minutes:

100 g of completely ion-free water

12 g of 28% by weight aqueous solution of

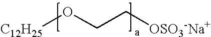

where a=3

6 g of 56.5% by weight aqueous solution of sodium di-2-ethylhexyl sulfosuccinate 80.0 g of n-butyl acrylate

103.0 g of methyl methacrylate
2 g of acrylic acid
2 g of acrylamide as a 50% by weight solution in water

Concurrently with the start of the addition of the above-described emulsion, the addition was commenced of a solution of 6 g of Na₂S₂O₈ in 50 g of water and continued over a period of 195 minutes. The temperature was maintained at 85° C. during the addition.

Immediately following completion of the addition of the above-described emulsion a further emulsion was added over 45 minutes. It consisted of

80 g of completely ion-free water

4 g of 28% by weight aqueous solution of

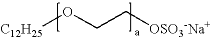

where a=3

2 g of 56.5% by weight aqueous solution of sodium di-2-ethylhexyl sulfosuccinate
1.25 g of acrylic acid

62.0 g of methyl methacrylate comprising a mixture of photoinitiators
4.00 g of FP1=isopropylthioxanthone
3.00 g of FP2=ethyl 4-dimethylaminobenzoate
4.00 g of FP3=benzyl dimethyl ketal
6.00 g of FP4=benzophenone

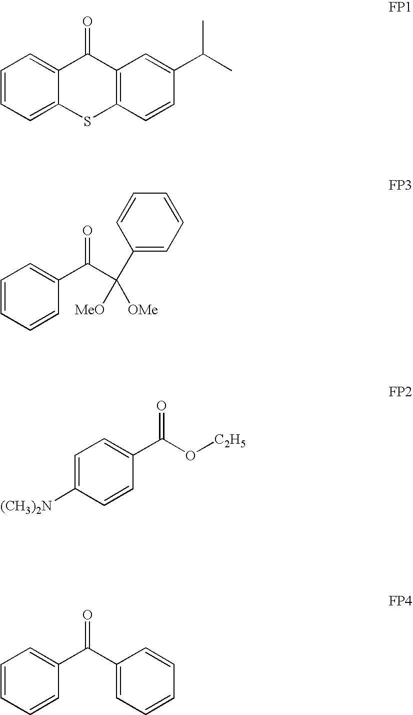

The photoinitiators FP1 to FP4 were dissolved in methyl methacrylate immediately before the emulsion was prepared.

On completion of the addition of the second above-described emulsion, stirring was continued at 85° C. for 30 minutes and then, for chemical deodorization (residual monomer removal), the concurrent addition was commenced of a solution of 5 g of tert-butyl hydroperoxide (70% by weight in water) in 11 g of distilled water and of a solution of 3 g of HO—CH₂—O—SO₂Na in 12 g of distilled water and continued for a period of 90 minutes.

Thereafter, the batch was cooled down to room temperature and adjusted to pH 7 with 25% by weight aqueous ammonia.

Thereafter, 58 g of compound VI c.1 was added as a radiation-curable component, and as a photocrosslinker, dropwise to the dispersion and the dispersion/emulsion was stirred for a further 20 minutes. At the end, biocide was added for preservation (2 g of Actizid MV Lösung from Thor Chemie with 1.5% active content, a mixture of 5-chloro-2-methyl-3(2H)-isothiazolone (“CIT”) and 2-methyl-3(2H)-isothiazolone (“MIT”), diluted with 50 g of water).

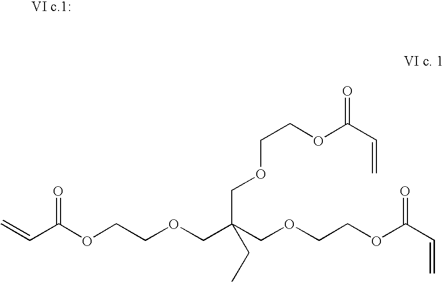

The dispersion thus obtainable was subsequently filtered through a 120 μm net and thereafter through a 15 μm net.

This gave an aqueous dispersion comprising pigment in particulate form that had been treated in accordance with the present invention. The solids content was 35% by weight, the dynamic viscosity was 20 mPa·s. The particle diameter distribution was determined and found to have a maximum at 130 nm.

### EXAMPLE 2

2 a) Mixing a pigment with a nonionic surface-active substance

A stirred ball mill was used to grind together:

1800 g of Pigment Yellow 138
450 g of n-C₁₈H₃₇O(CH₂CH₂O)₂₅H
24 g of glutaraldehyde
30 g of tetramethylolacetylenediurea

3696 g of distilled water

Grinding was continued until the pigment particles had an average diameter of 100 nm. A mixture of pigment particles and nonionic surface-active substance was obtained.

2 b) Dispersing the mixture from 2 a) in water

267 g of the mixture from 2 a) were dispersed with 300 g of distilled water by stirring in a 1.5 liter tank equipped with stirrer, nitrogen feed and three metering means. This gave a dispersion 2 b) of pigment in particulate form in an aqueous medium.

2 c) Polymerization

To dispersion 2 b) of pigment in particulate form were added 7.0 g of 28% by weight sodium lauryl sulfate as an aqueous solution and 40 g of styrene and a pH of 4.0 was set with formic acid. Nitrogen was then passed through the dispersion for 15 minutes. The mixture was then heated to 85° C. Thereafter, 0.3 g of tert-butyl hydroperoxide (70% by weight in water) and 0.2 g HO—CH₂—SO₂Na were added. The formation of a water-insoluble polymer on the pigment particles was observed.

2 d) Adding a comonomer in the form of emulsions and copolymerization

10 minutes after the addition of tert-butyl hydroperoxide and HO—CH₂—SO₂Na from step 2 c) an emulsion of the following composition was added over a period of 135 minutes:

100 g of completely ion-free water

12 g of 28% by weight aqueous solution of

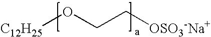

where a=3

6 g of 56.5% by weight aqueous solution of sodium di-2-ethylhexyl sulfosuccinate

80.0 g of n-butyl acrylate

103.0 g of methyl methacrylate
2 g of acrylic acid
9 g of a solution of 3 g of copolymerization-incorporable photoinitiator P 2.1 in 6 g of xylene isomer mixture

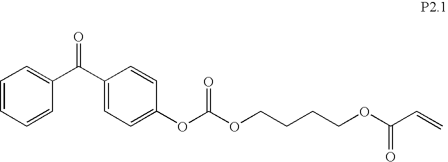

Concurrently with the start of the addition of the above-described emulsion, the addition was commenced of a solution of 6 g of Na₂S₂O₈ in 50 g of water and continued over a period of 195 minutes. The temperature was maintained at 85° C. during the addition.

Immediately following completion of the addition of the above-described emulsion a further emulsion was added over 45 minutes. It consisted of

80 g of completely ion-free water

4 g of 28% by weight aqueous solution of

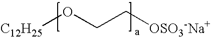

where a=3

2 g of 56.5% by weight aqueous solution of sodium di-2-ethylhexyl sulfosuccinate
1.25 g of acrylic acid

62.0 g of methyl methacrylate

(comprising a mixture of photoinitiators: FP1, FP2, FP3, FP4)
4.00 g of FP1=isopropylthioxanthone
3.00 g of FP2=ethyl 4-dimethylaminobenzoate
4.00 g of FP3=benzyl dimethyl ketal
6.00 g of FP4=benzophenone

The photoinitiators FP1 to FP4 were dissolved in methyl methacrylate immediately before the emulsion was prepared.

On completion of the addition, stirring was continued at 85° C. for 30 minutes and then, for chemical deodorization (residual monomer removal), the concurrent addition was commenced of a solution of 5 g of tert-butyl hydroperoxide (70% by weight in water) in 11 g of distilled water and of a solution of 3 g of HO—CH₂—O—SO₂Na in 12 g of distilled water and continued for a period of 90 minutes.

Thereafter, the batch was cooled down to room temperature and adjusted to pH 7 with 25% by weight aqueous ammonia. A dispersion is obtained.

Thereafter, 58 g of a mixture of radiation-curable components (photocrosslinkers) VI c.1 and VI d.2, weight ratio 1:1, were added dropwise to the dispersion and the dispersion subsequently stirred for 20 minutes.

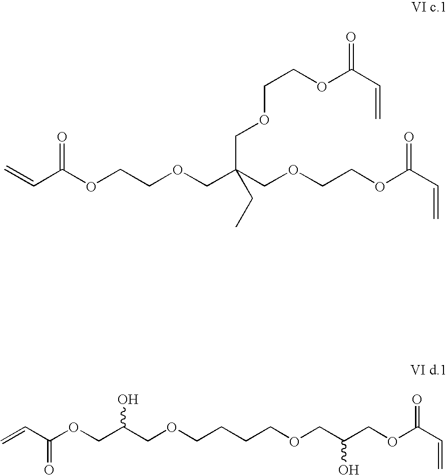

Thereafter, a biocide was added for preservation (2 g of Actizid MV Lösung from Thor Chemie with 1.5% active content, mixture of CIT and MIT, diluted with 50 g of water).

The dispersion thus obtainable was subsequently filtered through a 120 μm net and thereafter through a 15 μm net.

This gave an aqueous dispersion comprising pigment in particulate form that had been treated in accordance with the present invention. The solids content was 35% by weight, the dynamic viscosity was 18 mPa·s. The particle diameter distribution was determined and found to have a maximum at 156 nm.

3. Production and printing of inks comprising pigment in particulate form that has been treated in accordance with the present invention.

3.1. Production of ink 3.1

A dispersion produced according to example 1 was used to formulate an ink jet ink in accordance with the recipe which follows by mixing the following components:

27 g of dispersion according to 1 of pigment in particulate form which has been treated in accordance with the present invention (corresponds to 10.2 g of solids)

1.0g of urea

3.0 g of n-C₄H₉—(OCH₂CH₂)₃O—H (n-butyltriglycol)

0.25 g of 2,4,7,9-tetramethyl-5-decyne4,7-diol

16.0 g of glycerol

0.25 g of ethylene glycol

52.5 g of completely ion-free water

The mixture was stirred. This afforded ink 3.1 which is in accordance with the present invention, and this ink was introduced into ink jet cartridges.

Ink 3.1 which is in accordance with the present invention showed a dynamic viscosity of 4 mPa·s, measured at 25° C., and was suitable for printing in commonly used printers.

After the cartridge had been installed in a piezo printer (Epson 3000), ink 3.1 which is in accordance with the present invention was printed onto cotton (100% cotton, 250 g/m²) in the form of patterns.

After drying at 100° C. and immediate UV irradiation (2×120 W/cm, 10 m/min,

UV spectrum 250-450 nm), the printed cotton exhibited excellent service fastnesses.

Rub fastness dry: 4-5 (unirradiated 2-3)

Rub fastness wet: 3-4 (unirradiated 2)

Wash fastness: 4 (unirradiated 2-3)

The rub fastnesses were determined in accordance with German standard specification DIN 54021 and the wash fastness in accordance with German standard specification DIN 54011.

Production of ink 3.2

Example 3.1. was repeated except that example 2 pigment in particulate form that had been treated in accordance with the present invention was used instead of example 1.

Ink 3.2 which is in accordance with the present invention showed a dynamic viscosity of 4 mPa·s, measured at 25° C., and was suitable for printing in commonly used printers.

After the cartridge had been installed in a piezo printer (Epson 3000), ink 3.2 which is in accordance with the present invention was printed onto cotton (100% cotton, 250 g/m²) in the form of patterns.

After drying at 100° C. and immediate UV irradiation (2×120 W/cm, 10 m/min, UV spectrum 250-450 nm), the printed cotton exhibited excellent service fastnesses.

1. A formulation comprising
(B) at least one pigment in particulate form that has been treated according to a process which comprises steps of:
(a) mixing pigment in particulate form with at least one nonionic surface-active substance,
(b) dispersing the thus obtainable mixture of pigment in particulate form and nonionic surface-active substance in an aqueous medium,
(c) addition polymerizing at least one first monomer or addition copolymerizing a first mixture of comonomers in the presence of a dispersion according to b) to form water-insoluble polymer or copolymer on the surface of the pigments in particulate form,
(d) adding at least one second comonomer or a second mixture of comonomers and addition copolymerizing, and
(C) at least one radiation-curable component.

2. The formulation according to claim 1 wherein said radiation-curable component (B) is at least one molecule having at least two ethylenically unsaturated double bonds.

3. The formulation according to claim 1 wherein step d) adds at least one comonomer which serves as a photoinitiator.

4. The formulation according to claim 1 wherein step d) produces a polymer or copolymer having a glass transition temperature T_{g} of above 0° C.

5. The formulation according to claim 1 wherein the pigments in particulate form are organic pigments.

6. The formulation according to claim 1 wherein at least one monomer in step c) is a vinyl aromatic compound or is a compound of the general formula I 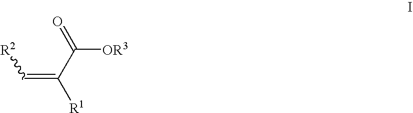
where
R¹ is selected from hydrogen, branched or unbranched C₁-C₁₀-alkyl,
R² is selected from hydrogen, branched or unbranched C₁-C₁₀-alkyl,
R³ is selected from branched or unbranched C₄-C₁₀-alkyl.

7. The formulation according to claim 1 wherein said first mixture of comonomers in step c) is a mixture of at least one vinyl aromatic compound and at least one compound of the general formula I.

8. The formulation according to claim 1 wherein R¹ and R² are both hydrogen in one compound of the general formula I.

9. The formulation according to claim 1 wherein step d) adds a monomer of the general formula II 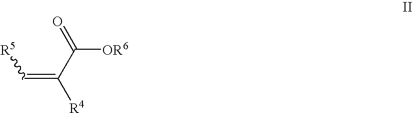
where
R⁴ is selected from hydrogen, branched or unbranched C₁-C₁₀-alkyl,
R⁵ is selected from hydrogen, branched or unbranched C₁-C₁₀-alkyl,
R⁶ is selected from branched or unbranched C₁-C₁₀-alkyl.

10. The formulation according to claim 1 wherein said second mixture of comonomers comprises at least one monomer of the general formula II.

11. The formulation according to claim 1 wherein R⁴ is hydrogen or methyl and R⁵ is hydrogen in at least one compound of the general formula II.

12. The formulation according to claim 11 wherein said second mixture of comonomers which is added in step d) includes at least one comonomer selected from vinyl aromatic compound and a compound of the general formula I.

13. The formulation according to claim 1, further comprising
(C) at least one plasticizer.

14. The method of using the formulation according to claim 13 for coloration of substrates.

15. A process for coloration of substrates, which comprises substrates being contacted with at least one formulation according to claim 1 and thereafter exposed to actinic radiation.

16. The process according to claim 15 wherein curing is effected by the action of actinic radiation.

17. A colored substrate obtainable according to a process of claim 15.

18. An ink for the ink jet process, comprising at least one formulation according to claim 1.

19. A print paste for textile printing, comprising at least one formulation according to claim 1.

20. A pigment in particulate form which have been treated according to a process which comprises steps of:
(a) mixing one or more pigments in particulate form with at least one nonionic surface-active substance,
(b) dispersing the thus obtainable mixture of pigment in particulate form and nonionic surface-active substance in an aqueous medium,
(c) addition polymerizing at least one first monomer or addition copolymerizing a first mixture of comonomers in the presence of a dispersion according to b) to form water-insoluble polymer or copolymer on the surface of the pigments in particulate form,
(d) adding a second mixture of comonomers and addition copolymerizing,
wherein said second mixture of comonomers comprises at least one comonomer which bears moieties useful for radiative curing.
